(19) United States
(12) Patent Application Publication
(10) Pub. No.: US 2026/0258849 A1
(43) Pub. Date: Sep. 3, 2026

(54) FRICTION MATERIAL

(71) Applicant: AKEBONO BRAKE INDUSTRY CO., LTD., Chuo-ku, Tokyo (JP)

(72) Inventors: Katsutoshi CHIKADA, Chuo-ku, Tokyo (JP); Haruka KURIHARA, Chuo-ku, Tokyo (JP)

(73) Assignee: AKEBONO BRAKE INDUSTRY CO., LTD., Chuo-ku, Tokyo (JP)

(21) Appl. No.: 18/878,728

(22) PCT Filed: Jul. 5, 2023
(86) PCT No.: PCT/JP2023/025047

§ 371 Date: Dec. 24, 2024

(30) Foreign Application Priority Data
Jul. 6, 2022 (JP) 2022-109182

(51) Int. Cl. F16D 69/02

(52) U.S. Cl. CPC F16D 69/026; F16D 2200/0065

(57) ABSTRACT

A friction material including: a friction modifier; a binder; and a fiber base material, in which the friction material is free of inorganic particles having an average particle diameter of 3 μm or less and a Mohs hardness of 6 or more, contains inorganic particles having an average particle diameter of 15 μm to 60 μm and a Mohs hardness of 6 or more, contains a titanate having an average particle diameter of 20 μm or more, and is free of a copper component.

### TECHNICAL FIELD

The present invention relates to a friction material used for a brake pad, a brake lining, a clutch facing, or the like of automobiles, railway vehicles, industrial machinery, or the like.

### BACKGROUND ART

A friction material used in brakes such as a disc brake and a drum brake, and clutches is made of raw materials such as a fiber base material having a reinforcement action, a friction modifier for imparting a friction action and adjusting a friction performance, and a binder for binding these components together.

In friction materials in the related art, materials containing a copper component, such as a copper fiber and a copper powder, have been used for various purposes. For example, since the copper component has high ductility and malleability, during braking using the friction material against a mating material (disc rotor), components of a friction material composition are likely to transfer to a surface of the mating material, forming a transfer film. It is believed that this transfer film acts as a protective film, thereby maintaining a friction coefficient and preventing wear of the mating material. In this way, control of formation of the transfer film is important from the viewpoint of improving brake properties.

However, in recent years, from the viewpoint of environmental pollution and harmfulness to the human body, there has been a demand for a friction material substantially free of a copper component.

As friction material components involved in the formation of the transfer film, various organic substances, titanates, and the like are known. Here, in a friction material described in Patent Literature 1, by using a combination of a plate-shaped titanate and hydrous magnesium silicate, a thickness of a transfer film can be controlled to an appropriate level. In addition, in a friction material described in Patent Literature 2, during light-load braking at low-speed, an excellent transfer film is formed of a spread product of a decomposition product of an organic filler and a titanate.

### CITATION LIST

### Patent Literature

Patent Literature 1: JP2012-197352A
Patent Literature 2: JP2017-2186A

### SUMMARY OF INVENTION

### Technical Problem

However, the friction materials described in Patent Literature 1 and Patent Literature 2 aim to increase the amount of the transfer film transferred to the surface of the mating material in order to complement the role of copper, but there is no mention of making the transfer film more uniform. On the other hand, when the transfer film is restricted too much, the stabilization of the friction coefficient and the prevention of wear are impaired, so that it is desirable to obtain a friction material that forms a uniform and appropriate transfer film.

In addition, during high-temperature braking, there is a problem that brake vibration is likely to occur due to an uneven temperature rise on the surface of the mating material. As the cause of the brake vibration, there is a concern that the runout of the disc rotor causes a surface pressure of the friction material to increase locally, resulting in non-uniform transfer and adhesive friction on the surface of the mating material. When the temperature rises in a portion where transfer and adhesive friction on the surface of the mating material increases, the surface of the mating material thermally expands non-uniformly, resulting in a difference in thickness on the surface of the mating material. When there is a difference in thickness on the surface of the mating material, contact between the friction material and the mating material is non-uniform, which can be one of the causes of the brake vibration.

Therefore, an object of the present invention is to provide a friction material that can appropriately form a transfer film and that can prevent brake vibration even being substantially free of a copper component.

### Solution to Problem

The inventors of the present invention have found that the above problem can be solved by being free of inorganic particles having a specific particle diameter and a specific hardness, containing inorganic particles having a specific particle diameter and a specific hardness, and containing a titanate having a specific particle diameter.

That is, the present invention is as follows.
[1] A friction material including:
a friction modifier;
a binder; and
a fiber base material, in which
the friction material
   is free of inorganic particles having an average particle diameter of 3 μm or less and a Mohs hardness of 6 or more,
   contains inorganic particles having an average particle diameter of 15 μm to 60 μm and a Mohs hardness of 6 or more,
   contains a titanate having an average particle diameter of 20 μm or more, and
   is free of a copper component.

### Advantageous Effects of Invention

According to the present invention, a degree of transfer of a titanate transfer film formed instead of a copper component transfer film can be controlled by using a titanate having a relatively large average particle diameter. Further, when the friction material is free of inorganic particles having a small average particle diameter that are easily taken up by the transfer film, but contains inorganic particles having a large average particle diameter as an abrasive, local transfer to a surface of a mating material can be prevented. Accordingly, it is possible to obtain a friction material that appropriately forms a transfer film and that has high wear properties, even being substantially free of a copper component.

### DESCRIPTION OF EMBODIMENTS

Hereinafter, the present invention will be described in detail, but these show examples of desirable embodiments, and the present invention is not specified in these contents.

A friction material according to the present invention is free of a copper component. Note that, the expression “be free of a copper component” means that the copper component is not substantially contained as an active component for exhibiting functions such as wear resistance, but does not mean that, for example, any copper component, such as an impurity inevitably contained in the friction material with a small amount, is not contained. Note that, it is preferable that the copper component mixed as an impurity is 0.5 mass % or less from the viewpoint of an environmental load.

The friction material according to the present invention contains a friction modifier, a fiber base material, and a binder.

The friction modifier is used to impart desired friction properties such as wear resistance, heat resistance, and fade resistance to the friction material. In the present invention, inorganic particles having a Mohs hardness of 6 or more function as an abrasive in the friction modifier, and a titanate functions as an inorganic filler in the friction modifier.

### <Friction Modifier: Abrasive>

The abrasive is a component that is blended for the purpose of grinding a disc rotor as a mating material and increasing a friction coefficient. The smaller the average particle diameter, the milder the abrasive. However, when it is too small, it is difficult to obtain a desired effect as an abrasive, and it is necessary to use a large amount of abrasive to obtain a grinding effect. In addition, the smaller the average particle diameter, the more easily the abrasive is taken up by a transfer film. When the abrasive is taken up by the transfer film, a difference in friction coefficient tends to occur between surfaces of the mating material with and without the transfer film. From such a viewpoint, the friction material according to the present invention is free of inorganic particles having an average particle diameter of 3 μm or less and a Mohs hardness of 6 or more (hereinafter, also referred to as inorganic particles (A)).

Further, the friction material according to the present invention contains inorganic particles having an average particle diameter of 15 μm to 60 μm and a Mohs hardness of 6 or more (hereinafter, also referred to as inorganic particles (C)). When inorganic particles having a specific large particle diameter are contained as the abrasive, during braking, a transfer film is appropriately formed, imparting high wear properties and appropriate aggressiveness to the mating material.

The average particle diameter of the inorganic particles (C) is preferably 17 μm to 50 μm, and more preferably 20 μm to 40 μm.

A content of the inorganic particles (C) in the friction material is preferably 1 mass % to 10 mass %, and more preferably 2 mass % to 8 mass %. When the content of the inorganic particle having a large particle diameter is within the above range, the thickness of the transfer film is sufficient.

The friction material according to the present invention preferably further contains, as the abrasive, inorganic particles having an average particle diameter of more than 3 μm and a Mohs hardness of 7 or more (hereinafter, also referred to as inorganic particles (B)). When the inorganic particles (C) having a large particle diameter and the inorganic particles (B) having a medium particle diameter are used in combination, it is possible to ensure both an appropriate thickness of the transfer film and appropriate aggressiveness to the mating material.

The average particle diameter of the inorganic particles (B) is more preferably 3.5 μm to 10 μm.

A content of the inorganic particles (B) in the friction material is preferably 1 mass % to 20 mass %, and more preferably 5 mass % to 15 mass %. When the content of the inorganic particles having a medium particle diameter is within the above range, the stability of the friction coefficient is improved.

A total content of the abrasive in the friction material is preferably 5 mass % to 30 mass % from the viewpoint of stable formation of the transfer film and the wear resistance.

Examples of inorganic particles to be used as the abrasive include alumina (Mohs hardness: 9), silica (Mohs hardness: 7), magnesium oxide (Mohs hardness: 6), zirconium oxide (Mohs hardness: 7), zirconium silicate (Mohs hardness: 7.5), chromium oxide (Mohs hardness: 6 to 7), triiron tetroxide (Fe₃O₄) (Mohs hardness: 6), and chromite (Mohs hardness: 5.5). These may be used alone or in combination of two or more thereof.

From the viewpoint of forming the transfer film on the surface of the mating material, the inorganic particles (C) are preferably one or more selected from magnesium oxide, zirconium oxide, zirconium silicate, and triiron tetroxide (Fe₃O₄).

From the viewpoint of increasing the friction coefficient, the inorganic particles (B) are preferably one or more selected from zirconium oxide and zirconium silicate.

The average particle diameter of the abrasive is determined by using a particle diameter (D50) corresponding to a cumulative percentage of 50% on a volume basis, as measured by a laser diffraction particle size distribution method.

### <Friction Modifier: Inorganic Filler>

### (Titanate)

The friction material according to the present invention contains a titanate having an average particle diameter of 20 μm or more (hereinafter, also referred to as a titanate (A)). The titanate spreads to a friction interface upon braking and contributes to the formation of the transfer film. When a titanate having a large particle diameter with an average particle diameter of 20 μm or more is contained, the transfer film is actively formed on the surface of the mating material, and high wear properties are obtained. In addition, it is preferable to use a combination of two or more types of titanates (A) having different particle diameters since this allows the formation of a transfer film having an appropriate thickness and density. In the case of using two types of titanates having different particle diameters, a difference in average particle diameter between the two is preferably 15 μm to 60 μm. In addition, from the viewpoint of keeping the thickness of the transfer film within an appropriate range, the average particle diameter of the titanate is preferably 200 μm or less.

From the above various viewpoints, the friction material according to the present invention preferably contains a titanate (A1) having an average particle diameter of 20 μm to 60 μm, and more preferably contains, in addition to the titanate (A1), a titanate (A2) having an average particle diameter of 40 μm to 160 μm.

A content of the titanate (A) in the friction material is preferably 1 mass % to 30 mass %. The titanate (A) having a large particle diameter is preferably contained in the above range since the stability of the friction coefficient and the formation of a titanate transfer film are sufficient. The content of the titanate (A) is more preferably 5 mass % to 25 mass %.

In the case of using the titanate (A1) and the titanate (A2) having different particle diameters in combination, a mixing ratio of the two is preferably 1:3 to 3:1 (mass ratio) from the viewpoint of uniform formation of the transfer film.

Note that, the friction material according to the present invention may contain a titanate having an average particle diameter of less than 20 μm, and from the viewpoint of ensuring the friction coefficient, the content of the titanate in the friction material is preferably 7 mass % or less.

The average particle diameter of the titanate is determined by using a particle diameter (D50) corresponding to a cumulative percentage of 50% on a volume basis, as measured by a laser diffraction particle size distribution method.

The particle shape of the titanate is preferably a scaly shape (layered shape), a columnar shape, a plate shape, a flat shape, a needle shape, a spherical shape, or an amoeba shape. Among them, at least one of a columnar shape and a spherical shape is particularly preferred. The titanate preferably has a columnar shape or a spherical shape since the transfer film is easily formed on the surface of the mating material. In the case of using two or more types of titanates, it is more preferable to combine a columnar shape and a spherical shape from the viewpoint of uniform formation of the transfer film. Note that, the “columnar shape” refers to a shape that is a substantially columnar shape, such as a rod shape, a cylindrical shape, prismatic columnar shape, a rectangular shape, a substantially cylindrical shape, or a substantially rectangular shape, and is distinguished from a needle shape or the like. The “spherical shape” means that the surface is uneven or the cross section has an approximately spherical shape, such as an elliptical shape, and is distinguished from a plate shape or the like. The particle shape can be observed using a scanning electron microscope (SEM) or the like.

As the titanate, potassium titanate, lithium titanate, lithium potassium titanate, sodium titanate, calcium titanate, magnesium titanate, magnesium potassium titanate, or the like can be used. Among them, potassium titanate is particularly preferred from the viewpoint of improving the strength of the transfer film.

The inorganic filler may include, in addition to the titanate, an inorganic filler generally used in the friction material, such as barium sulfate, calcium carbonate, calcium hydroxide, vermiculite, and mica.

A content of the inorganic filler in the friction material is preferably 20 mass % to 60 mass %, and more preferably 30 mass % to 50 mass %.

### <Friction Modifier: Others>

As the friction modifier, in addition to the abrasive and the inorganic filler, a friction modifier generally used in the friction material can be used, such as an organic filler, a solid lubricant, and a metal powder.

Examples of the organic filler include various rubber powders (a raw rubber powder, a tire powder, etc.), cashew dust, and melamine dust. These may be used alone or in combination of two or more thereof.

A content of the organic filler in the friction material is preferably 1 mass % to 20 mass %, and more preferably 1 mass % to 10 mass % in the entire friction material.

Examples of the solid lubricant include graphite, phosphate-coated graphite, antimony trisulfide, molybdenum disulfide, tin sulfide, and a fluoropolymer. These may be used alone or in combination of two or more thereof.

The phosphate-coated graphite is graphite used as a solid lubricant and coated with a phosphate. When the graphite is coated with a phosphate, it is possible to improve transfer at a high temperature and reduce a wear amount.

The phosphate for coating the graphite preferably contains a metal that constitutes the salt and that belongs to Group 1, 2, 12 or 13 of the periodic table (long period type). Specifically, preferred examples thereof include Na and K which belong to Group 1; Mg which belongs to Group 2; Zn which belongs to Group 12; and Al which belongs to Group 13. Specifically, it is preferable to use at least one selected from the group consisting of aluminum phosphates, magnesium phosphates, calcium phosphates, potassium phosphates, sodium phosphates, and zinc phosphates. Of these phosphates, hydrogen phosphates are preferred from the viewpoints of water solubility, pH, or the like.

As a method for coating the graphite with a phosphate, a known method described in, for example, JP2018-138652A can be used.

A content of the phosphate-coated graphite in the friction material is preferably 1 mass % to 10 mass % from the viewpoint of obtaining an appropriate thickness of a transfer layer.

A content of the solid lubricant in the friction material is preferably 1 mass % to 25 mass %, and more preferably 3 mass % to 20 mass %.

Examples of the metal powder include metal powders of aluminum, tin, and zinc. These may be used alone or in combination of two or more thereof.

A content of the metal powder in the friction material is preferably 0.5 mass % to 10 mass %, and more preferably 1 mass % to 5 mass %.

### <Fiber Base Material>

The fiber base material is used to reinforce the friction material.

As the fiber base material, various generally used organic fibers, inorganic fibers, and metal fibers can be used, and it is preferable not to use a copper fiber or a bronze fiber that contains a copper component.

Examples of the organic fiber include an aromatic polyamide (aramid) fiber and a flame-resistant acrylic fiber.

Examples of the inorganic fiber include a ceramic fiber, a biosoluble inorganic fiber, a glass fiber, a carbon fiber, and rock wool.

Examples of the metal fiber include a steel fiber.

These fiber base materials may be used alone or in combination of two or more thereof.

Here, a friction material containing a steel fiber as a metal fiber tends to generate metal catches in which a wear powder (metal component) from the mating material is transferred to a sliding surface of the friction material during braking, which may cause components of a friction material composition to be transferred to the surface of the mating material, hindering the formation of the transfer film. This is because the steel fiber is more likely to grind the mating material due to adhesive friction between the steel fiber and cast iron of the mating material such as a disc rotor. It is preferable that the friction material according to the present invention does not contain a metal fiber or contains a small amount of metal fiber, and a content of the metal fiber in the friction material is preferably less than 2 mass %.

In order to ensure sufficient mechanical strength, a content of the fiber base material in the friction material is preferably 1 mass % to 20 mass %, and more preferably 3 mass % to 15 mass %, in terms of a total amount of the fiber base material.

### <Binder>

The binder is blended for the purpose of binding together the filler and the fiber base material contained in the friction material composition and of imparting strength to the friction material.

As the binder to be contained in the friction material according to the present invention, various generally used binders can be used. Specific examples thereof include thermosetting resins such as a straight phenol resin, various modified phenol resins such as elastomer-modified phenol resins, a melamine resin, an epoxy resin, and a polyimide resin. Among them, an elastomer-modified phenol resin is preferred from the viewpoint of imparting flexibility and water repellency to the friction material. Examples of the elastomer-modified phenol resins include an acrylic rubber-modified phenol resin, a silicone rubber-modified phenol resin, and a nitrile rubber (NBR)-modified phenol resin. Note that, these binders can be used alone or in combination of two or more thereof.

A content of the binder in the friction material is preferably 1 mass % to 20 mass %, and more preferably 3 mass % to 15 mass % in the entire friction material.

As a specific embodiment of a method for producing the friction material according to the present invention, a known production process can be performed. For example, the friction material can be prepared by blending the above components, and subjecting the blended material to steps such as preforming, hot molding, heating, and grinding according to a usual production method.

General steps in producing a brake pad containing a friction material are as follows.
(a) a step of molding a pressure plate into a predetermined shape by using a sheet metal press,
(b) a step of applying a degreasing treatment, a chemical conversion treatment, and a primer treatment to the above pressure plate and coating the pressure plate with an adhesive,
(c) a step of blending raw materials such as a fiber base material, a friction modifier, and a binder, performing sufficient homogenization by mixing, and molding at a predetermined pressure at room temperature to prepare a preformed body,
(d) a hot molding step of integrally fixing the preformed body and the pressure plate coated with the adhesive by applying a predetermined temperature and pressure (molding temperature: 130° C. to 180° C., molding pressure: 30 MPa to 80 MPa, molding time: 2 minutes to 10 minutes), and
(e) a step of performing after-cure (150° C. to 300° C., 1 hour to 5 hours) and finally performing finishing treatments such as grinding, surface scorching, and painting.

As described above, the present description discloses the following friction material.
[1] A friction material including:
a friction modifier;
a binder; and
a fiber base material, in which
the friction material
   is free of inorganic particles having an average particle diameter of 3 μm or less and a Mohs hardness of 6 or more,
   contains inorganic particles having an average particle diameter of 15 μm to 60 μm and a Mohs hardness of 6 or more,
   contains a titanate having an average particle diameter of 20 μm or more, and
   is free of a copper component.
[2] The friction material according to [1], in which the titanate has a shape of at least one of a spherical shape and a columnar shape.
[3] The friction material according to [1] or [2], in which the titanate has a content of 1 mass % to 30 mass %.
[4] The friction material according to any one of [1] to [3], containing inorganic particles having an average particle diameter of more than 3 μm and a Mohs hardness of 7 or more.

### EXAMPLES

Hereinafter, the present invention will be described in detail with reference to Examples. However, the present invention is not limited to these Examples.

### Examples 1 to 12 and Comparative Examples 1 to 4

The raw materials of a friction material blending composition shown in Table 1 below were mixed in a mixer for 5 minutes, and the mixed material was charged into a mold and subjected to preforming and hot pressure molding to prepare a friction material.

The preforming was performed by applying a pressure of 5 MPa for 10 seconds at room temperature.

The preformed body was subjected to hot pressure molding at a pressure of 40 MPa and a molding temperature of 150° C. for 6 minutes to prepare a hot molded body.

The hot molded body was subjected to after-cure at a temperature of 250° C. for 3 hours, and then processed to a predetermined thickness, grinded, and painted to prepare each friction material.

### <Raw Materials>

Potassium titanate (average particle diameter: 40 μm, columnar shape), TERRACESS JSL-R manufactured by Otsuka Chemical Co., Ltd.

Potassium titanate (average particle diameter: 85 μm, spherical shape), TERRACESS DP-R101 manufactured by Otsuka Chemical Co., Ltd.

Potassium titanate (average particle diameter: 7 μm, plate shape), TERRACESS TF-S manufactured by Otsuka Chemical Co., Ltd.

Zirconium oxide (average particle diameter: 3.5 μm, Mohs hardness: 7), CC10 manufactured by SAINT-GOBAIN ZIRPRO

Zirconium silicate (average particle diameter: 1.1 μm, Mohs hardness: 7.5), MZ-1000B manufactured by DAIICHI KIGENSO KAGAKU KOGYO CO., LTD.

Triiron tetroxide (average particle diameter: 35 μm, Mohs hardness: 6), GIR348A manufactured by Powdertech Co., Ltd.

Triiron tetroxide (average particle diameter: 0.4 μm, Mohs hardness: 6), TAROX synthetic iron oxide BL100 manufactured by Titan Kogyo, Ltd.

Phosphate-coated graphite (treated with aluminum phosphate) was obtained by the following procedure with reference to JP2018-138652A.

Aluminum dihydrogen phosphate was dissolved in pure water to prepare an aqueous solution having a concentration of 1 mass %. To 100 parts by mass of this aqueous solution, 42 parts by mass of artificial graphite (G-152A, average particle diameter: 700 μm, manufactured by Tokai Carbon Co., Ltd.) was added, and the mixture was stirred at a temperature of 50° C. for 1 hour using a rotary blade mixer (PM-203 (model name), manufactured by AS ONE Corporation). The obtained mixture was dried in air for 24 hours, crushed, and then subjected to a heat treatment in vacuum at 800° C. for 3 hours. After the heat treatment, the mixture was pulverized in a mortar to obtain a graphite powder whose particle surfaces were coated with aluminum dihydrogen phosphate (phosphate-coated graphite).

### <Friction Material Evaluation Test>

For the friction materials in Examples and Comparative Examples prepared above, the vibration properties were evaluated by measuring a torque variation amount.

The test was conducted using a full-size dynamometer according to the AMS fade test. The torque variation amount was measured when braking the AMS fade section ten times, and the maximum torque variation amount was used for evaluation. The rotor runout was set to 50±5 μm.

The temperature at each position was measured using thermocouples inserted into the rotor every 90 degrees.

The evaluation results based on the following determination criteria are shown in Table 1.

Criteria for determining torque variation amount:
⊚: less than 50 N·m
◯:50 N·m or more and less than 80 N·m
Δ: 80 N·m or more and less than 100 N·m
x: 100 Nom or more

Criteria for determining temperature difference during one rotation:
⊚: less than 15° C.
◯:15° C. or more and less than 20° C.
Δ: 20° C. or more and less than 30° C.
x: 30° C. or more

TABLE 1

| (mass %) | | | | Ex. 1 | Ex. 2 | Ex. 3 | Ex. 4 | Ex. 5 | Ex. 6 | Ex. 7 | Ex. 8 |
|---|---|---|---|---|---|---|---|---|---|---|---|
| Blending | Binder | | Silicone-modified phenol | 10.0 | 10.0 | 10.0 | 10.0 | 10.0 | 10.0 | 10.0 | 10.0 |
| composition | | | resin | | | | | | | | |
| | Friction | Organic | Tire tread | 2.0 | 2.0 | 2.0 | 2.0 | 2.0 | 2.0 | 2.0 | 2.0 |
| | modifier | filler | Cashew dust | 4.0 | 4.0 | 4.0 | 4.0 | 4.0 | 4.0 | 4.0 | 4.0 |
| | | Inorganic | Barium sulfate | 40.0 | 35.0 | 30.0 | 25.0 | 20.0 | 30.0 | 35.0 | 25.0 |
| | | filler | Calcium hydroxide | 3.0 | 3.0 | 3.0 | 3.0 | 3.0 | 3.0 | 3.0 | 3.0 |
| | | | Mica | 2.0 | 2.0 | 2.0 | 2.0 | 2.0 | 2.0 | 2.0 | 2.0 |
| | | | Potassium titanate | 5.0 | 10.0 | 15.0 | 20.0 | 25.0 | — | 15.0 | 15.0 |
| | | | (average particle | | | | | | | | |
| | | | diameter: 40 μm), | | | | | | | | |
| | | | columnar shape | | | | | | | | |
| | | | Potassium titanate | — | — | — | — | — | 15.0 | — | — |
| | | | (average particle | | | | | | | | |
| | | | diameter: 85 μm), | | | | | | | | |
| | | | spherical shape | | | | | | | | |
| | | | Potassium titanate | — | — | — | — | — | — | — | — |
| | | | (average particle | | | | | | | | |
| | | | diameter: 7 μm), | | | | | | | | |
| | | | plate shape | | | | | | | | |
| | | Abrasive | Zirconium oxide (average | 10.0 | 10.0 | 10.0 | 10.0 | 10.0 | 10.0 | 5.0 | 15.0 |
| | | | particle diameter: 3.5 | | | | | | | | |
| | | | μm), Mohs hardness: 7 | | | | | | | | |
| | | | Zirconium silicate | — | — | — | — | — | — | — | — |
| | | | (average particle | | | | | | | | |
| | | | diameter: 1.1 μm), Mohs | | | | | | | | |
| | | | hardness: 7.5 | | | | | | | | |
| | | | Triiron tetroxide (average | 5.0 | 5.0 | 5.0 | 5.0 | 5.0 | 5.0 | 5.0 | 5.0 |
| | | | particle diameter: 35 μm), | | | | | | | | |
| | | | Mohs hardness: 6 | | | | | | | | |
| | | | Triiron tetroxide (average | — | — | — | — | — | — | — | — |
| | | | particle diameter: 0.4 | | | | | | | | |
| | | | μm), Mohs hardness: 6 | | | | | | | | |
| | | Solid | Tin sulfide | 3.0 | 3.0 | 3.0 | 3.0 | 3.0 | 3.0 | 3.0 | 3.0 |
| | | lubricant | Graphite | 8.0 | 8.0 | 8.0 | 8.0 | 8.0 | 8.0 | 8.0 | 8.0 |
| | | | Graphite (aluminum | — | — | — | — | — | — | — | — |
| | | | phosphate-treated) | | | | | | | | |
| | | | PTFE particles | 1.0 | 1.0 | 1.0 | 1.0 | 1.0 | 1.0 | 1.0 | 1.0 |
| | | Metal | Zinc powder | 1.0 | 1.0 | 1.0 | 1.0 | 1.0 | 1.0 | 1.0 | 1.0 |
| | | powder | | | | | | | | | |

| | | | | | | | | | |
|---|---|---|---|---|---|---|---|---|---|
| Fiber base material | Aramid fiber | 3.0 | 3.0 | 3.0 | 3.0 | 3.0 | 3.0 | 3.0 | 3.0 |

| | | | | | | | | |
|---|---|---|---|---|---|---|---|---|
| Biosoluble inorganic fiber | 3.0 | 3.0 | 3.0 | 3.0 | 3.0 | 3.0 | 3.0 | 3.0 |
| Copper fiber | — | — | — | — | — | — | — | — |

| Total (mass %) | | 100.0 | 100.0 | 100.0 | 100.0 | 100.0 | 100.0 | 100.0 | 100.0 |
|---|---|---|---|---|---|---|---|---|---|
| Evaluation | Torque variation amount (N · m) | 94 | 69 | 60 | 53 | 57 | 50 | 65 | 61 |
| | Temperature difference (° C.) during one | 25 | 19 | 17 | 14 | 17 | 15 | 20 | 24 |
| | rotation of rotor | | | | | | | | |
| Determination | Torque variation amount (N · m) | Δ | ◯ | ◯ | ◯ | ◯ | ◯ | ◯ | ◯ |
| | Temperature difference (° C.) during one | Δ | ◯ | ◯ | ⊚ | ◯ | ◯ | Δ | Δ |
| | rotation of rotor | | | | | | | | |

| | | | | | | | | Comp. | Comp. | Comp. | Comp. |
|---|---|---|---|---|---|---|---|---|---|---|---|
| (mass %) | | | | Ex. 9 | Ex. 10 | Ex. 11 | Ex. 12 | Ex. 1 | Ex. 2 | Ex. 3 | Ex. 4 |
| Blending | Binder | | Silicone-modified phenol | 10.0 | 10.0 | 10.0 | 10.0 | 10.0 | 10.0 | 10.0 | 10.0 |
| composition | | | resin | | | | | | | | |
| | Friction | Organic | Tire tread | 2.0 | 2.0 | 2.0 | 2.0 | 2.0 | 2.0 | 2.0 | 2.0 |
| | modifier | filler | Cashew dust | 4.0 | 4.0 | 4.0 | 4.0 | 4.0 | 4.0 | 4.0 | 4.0 |
| | | Inorganic | Barium sulfate | 33.0 | 27.0 | 27.0 | 27.0 | 20.0 | 30.0 | 30.0 | 30.0 |
| | | filler | Calcium hydroxide | 3.0 | 3.0 | 3.0 | 3.0 | 3.0 | 3.0 | 3.0 | 3.0 |
| | | | Mica | 2.0 | 2.0 | 2.0 | 2.0 | 2.0 | 2.0 | 2.0 | 2.0 |
| | | | Potassium titanate | 15.0 | 15.0 | 9.0 | 9.0 | — | — | 15.0 | — |
| | | | (average particle | | | | | | | | |
| | | | diameter: 40 μm), | | | | | | | | |
| | | | columnar shape | | | | | | | | |
| | | | Potassium titanate | — | — | 9.0 | 9.0 | — | — | — | — |
| | | | (average particle | | | | | | | | |
| | | | diameter: 85 μm), | | | | | | | | |
| | | | spherical shape | | | | | | | | |
| | | | Potassium titanate | — | — | — | — | 15.0 | 15.0 | — | 15.0 |
| | | | (average particle | | | | | | | | |
| | | | diameter: 7 μm), | | | | | | | | |
| | | | plate shape | | | | | | | | |
| | | Abrasive | Zirconium oxide (average | 10.0 | 10.0 | 10.0 | 10.0 | — | — | — | 10.0 |
| | | | particle diameter: 3.5 | | | | | | | | |
| | | | μm), Mohs hardness: 7 | | | | | | | | |
| | | | Zirconium silicate | — | — | — | — | 10.0 | 10.0 | 10.0 | — |
| | | | (average particle | | | | | | | | |
| | | | diameter: 1.1 μm), Mohs | | | | | | | | |
| | | | hardness: 7.5 | | | | | | | | |
| | | | Triiron tetroxide (average | 2.0 | 8.0 | 5.0 | 5.0 | — | — | — | 5.0 |
| | | | particle diameter: 35 μm), | | | | | | | | |
| | | | Mohs hardness: 6 | | | | | | | | |
| | | | Triiron tetroxide (average | — | — | — | — | 5.0 | 5.0 | 5.0 | — |
| | | | particle diameter: 0.4 | | | | | | | | |
| | | | μm), Mohs hardness: 6 | | | | | | | | |
| | | Solid | Tin sulfide | 3.0 | 3.0 | 3.0 | 3.0 | 3.0 | 3.0 | 3.0 | 3.0 |
| | | lubricant | Graphite | 8.0 | 8.0 | 8.0 | — | 8.0 | 8.0 | 8.0 | 8.0 |
| | | | Graphite (aluminum | — | — | — | 8.0 | — | — | — | — |
| | | | phosphate-treated) | | | | | | | | |
| | | | PTFE particles | 1.0 | 1.0 | 1.0 | 1.0 | 1.0 | 1.0 | 1.0 | 1.0 |
| | | Metal | Zinc powder | 1.0 | 1.0 | 1.0 | 1.0 | 1.0 | 1.0 | 1.0 | 1.0 |
| | | powder | | | | | | | | | |

| | | | | | | | | | |
|---|---|---|---|---|---|---|---|---|---|
| Fiber base material | Aramid fiber | 3.0 | 3.0 | 3.0 | 3.0 | 3.0 | 3.0 | 3.0 | 3.0 |
| | Biosoluble inorganic fiber | 3.0 | 3.0 | 3.0 | 3.0 | 3.0 | 3.0 | 3.0 | 3.0 |
| | Copper fiber | — | — | — | — | 10.0 | — | — | — |

| Total (mass %) | | 100.0 | 100.0 | 100.0 | 100.0 | 100.0 | 100.0 | 100.0 | 100.0 |
|---|---|---|---|---|---|---|---|---|---|
| Evaluation | Torque variation amount (N · m) | 66 | 59 | 49 | 44 | 169 | 141 | 125 | 132 |
| | Temperature difference (° C.) during one | 19 | 18 | 11 | 10 | 39 | 33 | 29 | 30 |
| | rotation of rotor | | | | | | | | |
| Determination | Torque variation amount (N · m) | ◯ | ◯ | ⊚ | ⊚ | X | X | X | X |
| | Temperature difference (° C.) during one | ◯ | ◯ | ⊚ | ⊚ | X | X | Δ | X |
| | rotation of rotor | | | | | | | | |

As seen from the results, in the friction materials in Examples 1 to 12 which are free of zirconium silicate having an average particle diameter of 1.1 μm and a Mohs hardness of 7.5 and triiron tetroxide having an average particle diameter of 0.4 μm and a Mohs hardness of 6, but contain triiron tetroxide having an average particle diameter of 35 μm and a Mohs hardness of 6 and contain potassium titanate having an average particle diameter of 40 μm or 85 μm, the torque variation amount and the temperature difference during one rotation of the rotor are all at a level that poses no problem.

Among them, the friction materials in Examples 11 and 12, which contain two types of potassium titanates having different average particle diameters and shapes, have a particularly small torque variation amount and temperature difference during one rotation of the rotor, and show good results.

In the friction materials in Comparative Examples 1 to 3 which contain zirconium silicate having an average particle diameter of 1.1 μm and a Mohs hardness of 7.5 and triiron tetroxide having an average particle diameter of 0.4 μm and a Mohs hardness of 6, but are free of triiron tetroxide having an average particle diameter of 35 μm and a Mohs hardness of 6, and the friction material in Comparative Example 4 which contains potassium titanate having an average particle diameter of 7 μm, both the torque variation amount and the temperature difference during one rotation of the rotor are greater than the reference values.

In particular, as seen from a comparison between Example 3 and Comparative Example 3 which are different in conditions of the abrasive and a comparison between Example 3 and Comparative Example 4 which are different in conditions of potassium titanate, being free of an abrasive having a specific Mohs hardness and average particle diameter, containing an abrasive having a specific Mohs hardness and average particle diameter, and containing potassium titanate having a specific average particle diameter are essential for reducing the torque variation amount and the temperature difference during one rotation of the rotor.

Although the present invention has been described in detail with reference to a specific embodiment, it will be apparent to those skilled in the art that various changes and modifications can be made without departing from the spirit and the scope of the present invention. The present application is based on a Japanese Patent Application (Japanese Patent Application No. 2022-109182) filed on Jul. 6, 2022, and the content thereof is incorporated herein by reference.

1. A friction material comprising:
a friction modifier;
a binder; and
a fiber base material, wherein
the friction material
is free of inorganic particles having an average particle diameter of 3 μm or less and a Mohs hardness of 6 or more,
contains inorganic particles having an average particle diameter of 15 μm to 60 μm and a Mohs hardness of 6 or more,
contains a titanate having an average particle diameter of 20 μm or more, and
is free of a copper component.

2. The friction material according to claim 1, wherein the titanate has a particle shape of at least one of a spherical shape and a columnar shape.

3. The friction material according to claim 1, wherein the titanate has a content of 1 mass % to 30 mass %.

4. The friction material according to claim 1, containing inorganic particles having an average particle diameter of more than 3 μm and a Mohs hardness of 7 or more.
